(19) United States
(12) Patent Application Publication
(10) Pub. No.: US 2025/0368774 A1
(43) Pub. Date: Dec. 4, 2025

(54) ULTRAVIOLET-CURABLE COMPOSITION AND USE THEREOF

(71) Applicant: DOW TORAY CO., LTD., Shinagawa-Ku, Tokyo (JP)

(72) Inventors: Takuya OGAWA, Ichihara-shi, Chiba (JP); Tomoka HOSOKAWA, Ichihara-Shi, Chiba (JP)

(21) Appl. No.: 18/865,385

(22) PCT Filed: May 19, 2023
(86) PCT No.: PCT/JP2023/018756

§ 371 Date: Aug. 21, 2025

(30) Foreign Application Priority Data
May 20, 2022 (JP) 2022-083169

(51) Int. Cl. C08G 59/22; C08G 59/30; C08K 5/45; C08K 5/56; C08L 63/00; C09D 163/00

(52) U.S. Cl. CPC C08G 59/223; C08G 59/226; C08G 59/306; C08K 5/45; C08K 5/56; C08L 63/00; C09D 163/00

(57) ABSTRACT

Provided is a UV-curable composition which, when cured, produces a product having a low dielectric constant and excellent workability when coated onto a base material, and which has a viscosity particularly suitable for coating by inkjet printing; and an organopolysiloxane serving as a main agent of the composition. The UV-curable composition comprises one or more organopolysiloxane (A) having, in each molecule, a UV-curable functional group, and a non-UV-curable monofunctional polycyclic functional group which may contain a hetero atom. The UV-curable composition is useful as an insulative coating agent.

### TECHNICAL FIELD

The present invention relates to an organopolysiloxane and a UV-curable composition that can be cured by actinic rays, such as ultraviolet rays or electron beams, in particular to a UV-curable composition containing an organosilicon compound, and preferably an organosilane and/or an organopolysiloxane, and particularly relates to a UV-curable composition that provides a cured product having favorable dielectric properties, particularly a low relative dielectric constant, and excellent coatability. The organopolysiloxane and UV-curable composition of the present invention are suitable as insulating materials for electronic and electrical devices, and particularly as materials for use as coating layers and protective layers. Furthermore, excellent coating properties and excellent wettability to base material are provided, and the materials are useful for spin coating, dispense coating, and inkjet printing.

### BACKGROUND ART

Due to high heat resistance and excellent chemical stability, silicone resins have been used as coating agents, potting agents, insulating materials, and the like for electronic and electrical devices. Silicone resins are reported to include UV-curable silicone compositions.

Touch panels are used in various display devices such as mobile devices, industrial equipment, car navigation systems, and the like. In order to improve detection sensitivity, electrical influence from light emitting sites such as light-emitting diodes (LED), organic EL devices (OLED), and the like must be suppressed, and an insulating layer is usually placed between the light-emitting part and the touchscreen.

On the other hand, thin display devices such as OLEDs and the like have a structure in which a plurality of functional thin layers are stacked. In recent years, studies have been started in order to improve the overall reliability of display devices, particularly flexible display devices, by laminating an insulating layer with high flexibility onto the touchscreen layer. In addition, the inkjet printing method has been adopted as a processing method for organic layers to improve productivity. Therefore, a material that can be processed by the inkjet printing method is required for the aforementioned insulating layer.

International Patent Application Publication WO2016/167347 and Japanese Unexamined Patent Application 2018-111792 disclose UV-curable resin compositions containing a polyfunctional cationic polymerizable compound including an epoxy group-containing polysiloxane, a monofunctional cationic polymerizable compound, and a cationic curing catalyst, and which can be processed by an inkjet printing method. As the monofunctional cationic polymerizable compound herein, no low-volatile compound containing a silicon atom is exemplified, and there is no mention of a compound having a non-UV-curable monofunctional polycyclic functional group.

Japanese Unexamined Patent Application 2019-189848 discloses a low-dielectric-constant UV-curable resin composition containing a polyfunctional cationic polymerizable compound including an epoxy group-containing polysiloxane, a monofunctional cationic polymerizable compound having a specific polycyclic structure, and a cationic curing catalyst, and which can be processed by an inkjet printing method. In a resin composition having a high weight ratio of a monofunctional cationic polymerizable compound, the dielectric constant of a cured product thereof is reduced, but there is a problem with the reliability of an organic EL display element manufactured using the resin composition. Furthermore, low-volatility compounds containing a silicon atom are not exemplified as the monofunctional cationic polymerizable compound herein. Furthermore, there is no disclosure of a polysiloxane having both a UV-curable functional group and a non-UV-curable monofunctional polycyclic functional group.

Furthermore, Macromolecules, Vol. 29, pp. 439-445, 1996, published by the American Chemical Society, describes a report on the synthesis and photopolymerization of a polysiloxane having epoxynorbornane groups at both terminals. Herein, there is no disclosure of a polysiloxane having both a UV-curable functional group and a non-UV-curable monofunctional polycyclic functional group.

Meanwhile, the present inventors have disclosed a UV-curable polysiloxane composition that contains an epoxy group-containing polyfunctional polysiloxane, an epoxy group-containing monofunctional polysiloxane, and a cationic curing catalyst, can be processed by an inkjet printing method, and has a low relative dielectric constant. (International Patent Application Publication WO2021/066084)

### RELATED ART DOCUMENTS

### Patent Documents

Patent Document 1: WO2016/167347
Patent Document 2: Japanese Unexamined Patent Application 2018-111792
Patent Document 3: Japanese Unexamined Patent Application 2019-189848
Patent Document 4: WO2021/066084
Non-Patent Document 1: Macromolecules, 1996, Vol. 29, pp. 439-445

### SUMMARY OF THE INVENTION

### Problem to be Solved by the Invention

As described above, UV-curable organopolysiloxane compositions are well known, but there is still a need for UV-curable compositions in which a cured product thereof has a low dielectric constant and has excellent workability, particularly low viscosity, for coating to base materials. The present invention provides: a curable composition containing a silicon atom, particularly a UV-curable composition, which provides a product obtained by curing that has a low dielectric constant and also has excellent workability when coated onto a base material; and an organopolysiloxane serving as a main agent thereof.

### Means for Solving the Problem

The present invention was completed based on the discovery that one or more organopolysiloxane having a UV-curable functional group and a non-UV-curable monofunctional polycyclic functional group which may contain a hetero atom, as well as a UV-curable composition containing the organopolysiloxane and being substantially free of an organic solvent, have low viscosity, and are excellent in workability when coated to a base material, and a cured product thereof exhibits an extremely low dielectric constant.

The present invention relates to: a novel organosilicon compound having a UV-curable functional group and a non-UV-curable monofunctional polycyclic functional group which may contain a hetero atom; and a UV-curable composition containing the same, particularly a UV-curable organopolysiloxane composition which is substantially free of organic solvents. The present composition is cured by forming a bond with a UV-curable functional group. However, the curing method is not limited to UV irradiation, and an arbitrary method in which a UV-curable functional group can cause a curing reaction can be used. For example, electron beam irradiation may be used to cure the composition of the present invention.

The UV-curable composition of the present invention is characterized in that the composition contains one or more organopolysiloxane having a UV-curable functional group and a non-UV-curable monofunctional polycyclic functional group which may contain a hetero atom, the composition does not contain an organic solvent, and when the composition is cured, a cured product thereof has a low dielectric constant, specifically, a dielectric constant at 23° C. of 3.0 or less.

The UV-curable functional group, which is provided by the one or more organopolysiloxane of the present invention having a UV-curable functional group and a non-UV-curable monofunctional polycyclic functional group which may contain a hetero atom, is preferably a cationic polymerizable reactive group. Furthermore, the cationic polymerizable reactive group is preferably an epoxy group-containing group.

The UV-curable composition of the present invention, which contains one or more organopolysiloxane having a UV-curable functional group and a non-UV-curable monofunctional polycyclic functional group which may contain a hetero atom (hereinafter, may be referred to as “component (A)”), preferably has an overall compositional viscosity, as measured at 25° C. using an E-type viscometer, of 500 mPads or less.

The aforementioned component (A) is preferably a linear, branched, or cyclic organopolysiloxane expressed by the average compositional formula:

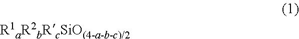

(where R¹ represents a UV-curable functional group, and R² represents a non-UV-curable monofunctional polycyclic functional group which may contain a hetero atom;
R′ represents an unsubstituted or fluorine-substituted monovalent hydrocarbon group, excluding the UV-curable functional group and non-UV-curable monofunctional polycyclic functional group which may contain a hetero atom;
a, b, and c are numbers satisfying the following conditions: 1≤a+b+c≤3, 0.04≤a/(a+b+c)<0.5, and 0.04≤b/(a+b+c)<0.5, and there is at least one R¹ and at least one R² in each molecule.).

The number of silicon atoms in component (A) above is preferably in the range of 2 to 10 on average.

The UV-curable composition of the present invention preferably includes: the aforementioned component (A); and one or more organopolysiloxane (B) having, in each molecule, two or more UV-curable functional groups on average and not having a non-UV-curable monofunctional polycyclic functional group which may contain a hetero atom.

Component (A) is preferably one or more organopolysiloxane having a UV-curable functional group and a non-UV-curable monofunctional polycyclic functional group which may contain a hetero atom, the organopolysiloxane being selected from the group consisting of:
linear organopolysiloxanes expressed by the following formula (2):

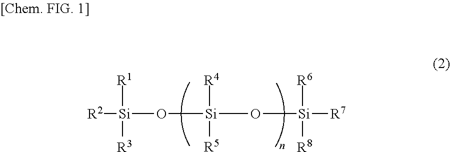

(where, of all of the R¹ to R⁸ groups, one or more on average per molecule is a UV-curable functional group, one or more on average per molecule is a non-UV-curable monofunctional polycyclic functional group which may contain a hetero atom, and the remainder of the R¹ to R⁸ are each independently an unsubstituted or fluorine-substituted monovalent hydrocarbon group; and n is a number of 0 or more and 10 or less); branched organopolysiloxanes expressed by average unit formula:

(R₃SiO_{1/2})ₑ(R²SiO_{2/2})_{f}(RSiO_{3/2})_{g}(SiO_{4/2})ₕ (3)
(where R each independently represent a group selected from UV-curable functional groups, non-UV-curable monofunctional polycyclic functional groups which may contain a hetero atom, and unsubstituted or fluorine-substituted monovalent hydrocarbon groups; of all Rs, one or more on average is the UV-curable functional group and one or more on average is the non-UV-curable monofunctional polycyclic functional group which may contain a hetero atom; (g+h) is a positive number; e is 0 or a positive number; and f is a number in the range of 0 to 10.);
cyclic organopolysiloxanes expressed by following formula (4):

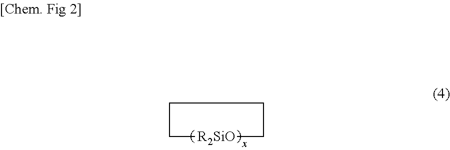

(where R each independently represent a group selected from UV-curable functional groups, non-UV-curable monofunctional polycyclic functional groups which may contain a hetero atom, and unsubstituted or fluorine-substituted monovalent hydrocarbon groups; x is an integer from 3 to 10; and each molecule contains, on average, one or more UV-curable functional groups and, on average, one or more non-UV-curable monofunctional polycyclic functional group which may contain a hetero atom); and mixtures of two or more organopolysiloxanes arbitrarily selected therefrom.

The number of UV-curable functional groups in component (A) is preferably two or less on average per molecule, and the number of non-UV-curable monofunctional polycyclic functional groups which may contain a hetero atom is two or less on average per molecule.

Component (A) is preferably a linear or branched organopolysiloxane having, only on both molecular chain terminals, a UV-curable functional group and a non-UV-curable monofunctional polycyclic functional group which may contain a hetero atom, and having, on average, 5 or less silicon atoms.

The UV-curable composition of the present invention preferably further includes an organosilicon compound (C) selected from the group consisting of one or more linear branched and cyclic organosilanes and organopolysiloxanes expressed by the following average compositional formula (5) and having, in each molecule, one UV-curable functional group and not having a non-UV-curable monofunctional polycyclic functional group which may contain a hetero atom.

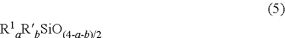

(where R¹ represents a UV-curable functional group;
R′ represents an unsubstituted or fluorine-substituted monovalent hydrocarbon group excluding a UV-curable functional group; a and b are numbers satisfying the following conditions: 1<a+b≤4 and 0.04≤a/(a+b)≤0.25, and the number of Rs in each molecule is 1.)

Component (B) is preferably a linear, branched or cyclic organopolysiloxane expressed by the average compositional formula:

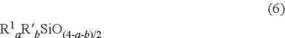

(where R¹ represents a UV-curable functional group; and
R′ represents an unsubstituted or fluorine-substituted monovalent hydrocarbon group excluding a UV-curable functional group, a and b are numbers satisfying the following conditions: 1≤a+b≤3 and 0.04≤a/(a+b)≤0.5, and there are at least two Rs in each molecule.).

Component (B) is preferably a silicon-containing compound having two or more UV-curable functional groups in each molecule, the compound being selected from the group consisting of:
linear organopolysiloxanes expressed by the following (2′):

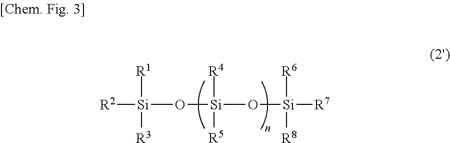

(where, of all of the R¹ to R⁸ groups, there are two or more UV-curable functional groups in each molecule; the remainder of the R¹ to R⁸ each independently represent an unsubstituted or fluorine-substituted monovalent hydrocarbon group; and n is a numerical value of 0 or more and 8 or less);
branched organopolysiloxanes expressed by the average unit formula:

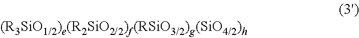

(where R each independently represent a group selected from UV-curable functional groups and unsubstituted or fluorine substituted monovalent hydrocarbon groups; two or more on average of all Rs are UV-curable functional groups; (g+h) is a positive number;
e is 0 or a positive number; and f is a number in the range of 0 to 10.); and
cyclic organopolysiloxanes expressed by the following formula (4′):

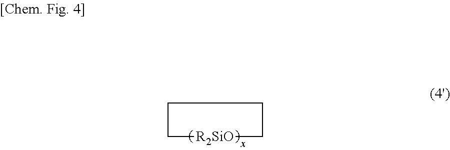

(where R each independently represents a group selected from UV-curable functional groups and unsubstituted or fluorine-substituted monovalent hydrocarbon groups; x is an integer of 3 to 10; and two or more UV-curable functional groups are present in each molecule).

Component (B) is preferably a linear organopolysiloxane having, on average, 5 or less silicon atoms and having two UV-curable functional groups in each molecule.

In one preferred aspect of the present invention, the non-UV-curable monofunctional polycyclic functional group which may contain a hetero atom in component (A) is a group expressed by the following formula (7).

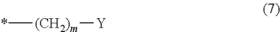

(where m is a number of 0 or more and 6 or less; and Y represents a group selected from the group consisting of optionally substituted norbornanyl groups, optionally substituted norbornenyl groups, optionally substituted norpinane groups, optionally substituted norpinene groups, optionally substituted pinane groups, optionally substituted pinene groups, optionally substituted dicyclopentanyl groups, and optionally substituted dicyclopentenyl groups, and is bonded to a silicon atom expressed by *)

In one preferred aspect of the present invention, the non-UV-curable polycyclic functional group which may contain a hetero atom in component (A) is an optionally substituted norbornanyl group.

Component (A) is preferably 1-[2-(3,4-epoxycyclohexyl)ethyl]-3-norbornanyl-1,1,3,3-tetramethyldisiloxane or bis[2-(3,4-epoxycyclohexyl)ethyl]dimethylsiloxy-bisnorbornanyl dimethylsiloxysilane.

The viscosity of the entire composition, as measured at 25° C. using an E-type viscometer, is preferably 5 to 50 mPa·s.

The present invention further provides an insulative coating agent containing the aforementioned UV-curable composition. The UV-curable composition of the present invention is useful as an insulative coating agent.

The present invention further provides a cured product of the aforementioned UV-curable composition. Furthermore, the present invention also provides a method of using the cured product as an insulative coating layer.

The present invention further provides a display device such as a liquid crystal display, organic EL display, or organic EL flexible display that includes a layer containing a cured product of the aforementioned UV-curable composition.

### DESCRIPTION OF THE PREFERRED EMBODIMENTS

A configuration of the present invention will be further described in detail below. The present invention relates to: one or more organopolysiloxane having a UV-curable functional group and a non-UV-curable monofunctional polycyclic functional group which may contain a hetero atom; and a UV-curable composition containing the same. The curable composition contains (A) one or more organopolysiloxanes having a UV-curable functional group and a non-UV-curable monofunctional polycyclic functional group which may contain a hetero atom, as a curable essential component, and may contain, if necessary, a component selected from: (B) one or more organopolysiloxanes having an average of two or more UV-curable functional groups in each molecule and having no non-UV-curable monofunctional polycyclic functional group which may contain a hetero atom; (C) one or more organosilicon compounds selected from the group consisting of linear, branched, or cyclic organosilanes and organopolysiloxanes having one UV-curable functional group in each molecule and having no non-UV-curable monofunctional polycyclic functional group which may contain a hetero atom; a photocationic polymerization initiator; and various additives. The curable composition of the present invention may contain an organic solvent, but preferably does not substantially contain an organic solvent.

In the present specification, the term “organosilicon compound” is used as a term to refer to a concept that includes organosilanes, organosiloxane oligomers, and organopolysiloxanes.

In the present specification, the term “polysiloxane” refers to a siloxane unit (Si—O) with a degree of polymerization of two or more, in other words with an average of two or more Si—O bonds per molecule. Polysiloxanes include siloxane oligomers such as disiloxanes, trisiloxanes, tetrasiloxanes, and the like, as well as siloxane polymers with higher degrees of polymerization.

### [Component (A)]

Component (A) is one or more organopolysiloxane including: a UV-curable functional group; and a non-UV-curable monofunctional polycyclic functional group which may contain a hetero atom. The molecular structure thereof can be arbitrary so long as the object can be achieved. Component (A) is a novel organopolysiloxane, and the UV-curable composition of the present invention contains component (A) as an essential component.

Component (A) preferably has a viscosity at 25° C. of 5 to 500 mPa·s, and more preferably in the range of 5 to 300 mPa·s.

Furthermore, component (A) contains 2 to 10 silicon atoms per molecule, and preferably in a range of 2 to 5.

The organopolysiloxane of component (A) is a linear, branched, or cyclic organopolysiloxane, and preferably a linear or branched organopolysiloxane expressed by the following average compositional formula:

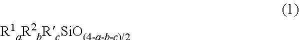

In formula (1),
R¹ represents a UV-curable functional group; R² represents a non-UV-curable monofunctional polycyclic functional group which may contain a hetero atom; R′ represents an unsubstituted or fluorine-substituted monovalent hydrocarbon group excluding a UV-curable functional group and non-UV-curable monofunctional polycyclic functional group which may contain a hetero atom; and a, b, and c are numbers satisfying the following conditions: 1≤a+b+c≤3, 0.04≤a/(a+b+c)<0.5, and 0.04≤b/(a+b+c)<0.5, preferably 2≤a+b+c≤3, 0.08≤a/(a+b+c)≤0.25, and 0.08≤b/(a+b+c)≤0.25.

The UV-curable functional group represented by R¹ in formula (1) is an organic group capable of generating a bond between each group by UV irradiation in the presence or absence of a photoinitiator. Examples of the UV-curable functional groups can include radical polymerizable functional groups and cationic polymerizable functional groups. Radical polymerizable functional groups are not particularly limited so long as they are a functional group that can form a new bond by a radical reaction mechanism, and particularly a bond between radical polymerizable functional groups. Examples can include acrylic groups, methacrylic groups, maleimide groups, and organic groups containing any of these groups. Specific examples of the radical polymerizable functional group include groups such as acryloxypropyl, methacryloxypropyl, acrylamidopropyl, methacrylamidopropyl, 3-(N-maleimido) propyl, and the like. Examples of cationic polymerizable functional groups include vinyl ether groups, epoxy group-containing groups, oxetane group-containing groups, and other groups, such as CH₂═CH—O—(CH₂)ₙ-(where n is an integer from 3 to 20), glycidyloxy-(CH₂)ₙ-(where n is an integer from 3 to 20), 3,4-epoxycyclohexyl —(CH₂)ₙ-(where n is an integer from 2 to 20), and the like.

The UV-curable functional group is preferably a cationic polymerizable functional group, and more preferably an epoxy group-containing group. Examples of particularly preferable groups include glycidyloxypropyl groups, epoxycyclohexylalkyl groups, and particularly a 3,4-epoxycyclohexylethyl group. The linear, branched, or cyclic organopolysiloxanes expressed by the average compositional formula above have at least one UV-curable functional group (R¹) on average per molecule. The number of UV-curable groups per molecule is, on average, 1 to 3, and preferably 1 to 2.

The non-UV-curable monofunctional polycyclic functional group which may contain a hetero atom represented by R² in formula (1) refers to a monofunctional functional group which has a chemical structure in which a plurality of rings, which may contain a hetero atom, are linked in a form in which two or more atoms are shared, and which does not have ultraviolet-curability. Due to the bulkiness of the functional group, the functional group is effective in controlling the crosslinking density in a cured product and reducing the dielectric constant of the cured product. Examples include saturated monovalent polycyclic hydrocarbon groups, unsaturated monovalent polycyclic hydrocarbon groups, oxygen-containing saturated monovalent polycyclic functional groups, and oxygen-containing unsaturated monovalent polycyclic functional groups. Saturated monovalent polycyclic hydrocarbon groups and unsaturated monovalent polycyclic hydrocarbon groups are preferably used. A group expressed by the following formula (7) is particularly preferred.

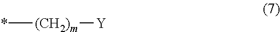

(where m is a number of 0 or more and 6 or less; and Y represents a group selected from the group consisting of optionally substituted norbornanyl groups, optionally substituted norbornenyl groups, optionally substituted norpinane groups, optionally substituted norpinene groups, optionally substituted pinane groups, optionally substituted pinene groups, optionally substituted dicyclopentanyl groups, and optionally substituted dicyclopentenyl groups, and is bonded to a silicon atom expressed by *) m is preferably 0 or 2, and Y is preferably an optionally substituted norbornanyl group, an optionally substituted norbornenyl group, an optionally substituted dicyclopentanyl group, or an optionally substituted dicyclopentenyl group.

Specific examples include norbornanyl groups, ethylnorbornenyl groups, ethylnorbornanyl groups, dicyclopentadienyl groups, dihydrodicyclopentadienyl groups, and hydroxydicyclopentadienyl groups. Norbornanyl groups and ethylnorbornenyl groups are particularly preferable, and norbornanyl are most preferable.

The linear, branched, or cyclic organopolysiloxanes expressed by the aforementioned average compositional formula have a non-UV-curable monofunctional polycyclic functional group (R²) which may contain, on average, at least one hetero atom per molecule. The number of R²s per molecule is, on average, 1 to 3, and preferably 1 to 2.

R′ represents a monovalent hydrocarbon group, which includes unsubstituted monovalent hydrocarbon groups and fluorine-substituted monovalent hydrocarbon groups. The unsubstituted or fluorine-substituted monovalent hydrocarbon group is preferably a group selected from unsubstituted or fluorine substituted alkyl, cycloalkyl, arylalkyl, and aryl groups having 1 to 20 carbon atoms. Examples of the alkyl groups above include methyl, ethyl, n-propyl, isopropyl, n-butyl, tert-butyl, sec-butyl, pentyl, octyl, and other groups, and methyl groups are particularly preferable. Examples of the cycloalkyl groups above include cyclopentyl, cyclohexyl, and the like. Examples of the arylalkyl groups above include benzyl, phenylethyl groups, and the like. Examples of the aryl groups above include phenyl groups, naphthyl groups, and the like. Examples of fluorine-substituted monovalent hydrocarbon groups include 3,3,3-trifluoropropyl and 3,3,4,4,5,5,6,6,6-nonafluorohexyl groups. The 3,3,3-trifluoropropyl group is preferred as the fluorine-substituted monovalent hydrocarbon group.

The organopolysiloxane expressed by the aforementioned formula (1) preferably has a viscosity at 25° C. of 5 to 500 mPa·s, and more preferably in the range of 5 to 300 mPa·s. The viscosity of the organopolysiloxane can be adjusted by changing the ratio of a and b in formula (1) as well as the molecular weight.

The organopolysiloxane expressed by formula (1) preferably has on average 2 to 10 silicon atoms per molecule, more preferably 2 to 8 atoms, and particularly preferably 2 to 5 atoms.

In one preferred aspect, the organopolysiloxane of the present invention is a compound expressed by the following formula (2).

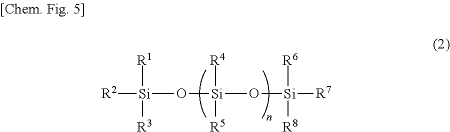

Similar to the compound expressed by formula (1) above, among all of the R¹ to R⁸ groups in the organopolysiloxane expressed by formula (2), on average, one or more per molecule are UV-curable functional groups, and on average, one or more per molecule are non-UV-curable monofunctional polycyclic functional groups which may contain a hetero atom. The remainder of R¹ to R⁸ each independently represent an unsubstituted or fluorine-substituted monovalent hydrocarbon group; and n is a number of 0 or more and 8 or less.

The aforementioned radical polymerizable group and cationic polymerizable group can be used as the UV-curable functional group. The number of UV-curable functional groups per molecule is, on average, 1 to 2, and preferably 1.

Similarly, the non-UV-curable monofunctional polycyclic functional group which may contain a hetero atom may be the same as the functional group described above. The number of the functional groups per molecule is, on average, 1 to 2, and preferably 1.

The aforementioned groups can also be applied to R¹ to R⁸ other than the UV-curable functional group and the non-UV-curable monofunctional polycyclic functional group which may contain a hetero atom in formula (2). A methyl group, a phenyl group, or a 3,3,3-trifluoropropyl group can be preferably used.

One of R₁ to R₃ in formula (2) is preferably a UV-curable functional group, and one of R₆ to R₈ is preferably a non-UV-curable monofunctional polycyclic functional group which may contain a hetero atom.

The organopolysiloxane of formula (2) can be used as one type or as a mixture of two or more types. If two or more organopolysiloxanes are used as a mixture, the viscosity of the mixture at 25° C. is preferably the viscosity described above.

Furthermore, the aforementioned compound of formula (1) may be a branched organopolysiloxane expressed by the following average unit formula (3).

Average unit formula:

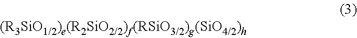

In formula (3), R each independently represent a group selected from UV-curable functional groups, non-UV-curable monofunctional polycyclic functional groups which may contain a hetero atom, and unsubstituted or fluorine-substituted monovalent hydrocarbon groups; of all Rs, one or more on average is the UV-curable functional group and one or more on average is the non-UV-curable monofunctional polycyclic functional group which may contain a hetero atom; (g+h) is a positive number; e is 0 or a positive number; and f is a number in the range of 0 to 10.

The UV-curable functional group, the non-UV-curable monofunctional polycyclic functional group which may contain a hetero atom, and the monovalent hydrocarbon group are as defined above for formula (1). Furthermore, a preferred viscosity of the organopolysiloxane expressed by formula (3) is as specified for the organopolysiloxane expressed by formula (1).

The number of UV-curable functional groups provided by the organopolysiloxane expressed by formula (3) is preferably 1 to 5, more preferably 1 to 4, particularly preferably 1 to 3, and most preferably 2 to 3, per molecule. Furthermore, the number of non-UV-curable monofunctional polycyclic functional groups which may contain a hetero atom in each molecule is preferably 1 to 5, more preferably 1 to 4, particularly preferably 1 to 3, and most preferably 2 to 3.

The organopolysiloxane expressed by formula (3) preferably has 4 to 20 silicon atoms per molecule, more preferably 4 to 12 atoms, and particularly preferably 4 to 10 atoms.

Furthermore, the compound of formula (1) above may be a cyclic organopolysiloxane expressed by the following formula (4).

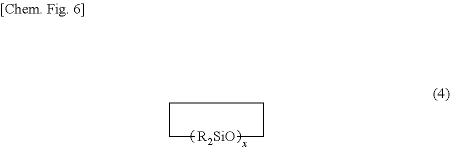

In formula (4), R each independently represent a group selected from UV-curable functional groups, non-UV-curable monofunctional polycyclic functional groups which may contain a hetero atom, and unsubstituted or fluorine-substituted monovalent hydrocarbon groups; and of all Rs, one or more on average is the UV-curable functional group and one or more on average is the non-UV-curable polycyclic functional group which may contain a hetero atom. x is an integer from 3 to 10.

The UV-curable functional group, the non-UV-curable monofunctional polycyclic functional group which may contain a hetero atom, and the monovalent hydrocarbon group are as defined above for formula (1). Furthermore, a preferred viscosity of the organopolysiloxane expressed by formula (4) is as specified for the organopolysiloxane expressed by formula (1).

The number of UV-curable functional groups included in the organopolysiloxane expressed by formula (4) is preferably 1 to 3, and more preferably 1 to 2, per molecule.

Furthermore, the number of non-UV-curable monofunctional polycyclic functional groups which may contain a hetero atom in each molecule is preferably 1 to 3, and more preferably 1 to 2.

Specific examples of the organopolysiloxane expressed by the aforementioned formula (1), and particularly formula (2) or formula (3), include: 1-[2-(3,4-epoxycyclohexyl)ethyl]-3-norbornanyl-1,1,3,3-tetramethyldisiloxane; 1-[2-(3,4-epoxycyclohexyl)ethyl]-5-norbornanyl-1,1,3,3,5,5-hexamethyltrisiloxane; 1-[2-(3,4-epoxycyclohexyl)ethyl]-9-norbornanyl-1,1,3,3,5,5,7,7,9,9-decamethylpentasiloxane; 1-[2-(3,4-epoxycyclohexyl)ethyl]-13-norbornanyl-1,1,3,3,5,5,7,7,9,9,11,11,13,13-tetradecamethylheptasiloxane; 1-[2-(3,4-epoxycyclohexyl)ethyl]-17-norbornanyl-1-(3-1,1,3,3,5,5,7,7,9,9,11,11,13,13,15,15,17,17-octadecamethylnonasiloxane; glycidoxypropyl)-3-norbornanyl-1,1,3,3-tetramethyldisiloxane; 1-(3-glycidoxypropyl)-5-norbornanyl-1,1,3,3,5,5-hexamethyltrisiloxane; 1-(3-glycidoxypropyl)-9-norbornanyl-1,1,3,3,5,5,7,7,9,9-decamethylpentasiloxane; 1-(3-glycidoxypropyl)-13-norbornanyl-1,1,3,3,5,5,7,7,9,9,11,11,13,13-tetradecamethylheptasiloxane; 1-(3-glycidoxypropyl)-17-norbornanyl-1,1,3,3,5,5,7,7,9,9,11,11,13,13,15,15,17,17-octadecamethylnonasiloxane; dimethylsiloxy/(methyl-3,4-epoxycyclohexylethylsiloxy)/(methyl-norbornanylsiloxy) copolymers capped with trimethylsilyl on both terminals; dimethylsiloxy/(methyl-norbornanylsiloxy) copolymers capped with (3,4-epoxycyclohexylethyldimethylsilyl) on both terminals; dimethylsiloxy/(methyl-(3,4-epoxycyclohexylethyl) siloxy) copolymers capped with (norbornanyldimethylsilyl) on both terminals; dimethylsiloxy/(methyl-norbornanylsiloxy) copolymers capped with (3-glycidoxypropyldimethylsilyl) on both terminals; dimethylsiloxy/(methyl-(3-glycidoxypropyl) siloxy) copolymers capped with (norbornanyldimethylsilyl) on both terminals; methyl ([2-(3,4-epoxycyclohexyl)ethyl]dimethylsiloxy) bis(norbornanyldimethylsiloxy) silane; methyl(norbornanyldimethylsiloxy) bis([2-(3,4-epoxycyclohexyl)ethyl]dimethylsiloxy) silane; (norbornanyldimethylsiloxy)tris([2-(3,4-epoxycyclohexyl)ethyl]dimethylsiloxy) silane; and bis([2-(3,4-epoxycyclohexyl)ethyl]dimethylsiloxy) bis(norbornanyldimethylsiloxy) silane. Of these, 1-[2-(3,4-epoxycyclohexyl)ethyl]-3-norbornanyl-1,1,3,3-tetramethyldisiloxane and bis[2-(3,4-epoxycyclohexyl)ethyl]dimethylsiloxy-bisnorbornanyl dimethylsiloxysilane are most preferably used.

Furthermore, specific examples of the organopolysiloxane expressed by formula (4) include: 1,3,4,5,7,8-hexamethyl-2-[2-(3,4-epoxycyclohexyl)ethyl]-6-norbornanylcyclotetrasiloxane; 1,3,5,6,7,8-hexamethyl-2-[2-(3,4-epoxycyclohexyl)ethyl]-4-norbornanylcyclotetrasiloxane; 1,3,5,7-tetramethyl-2,4-di[2-(3,4-epoxycyclohexyl)ethyl]-6,8-dinorbornanylcyclotetrasiloxane; 1,3,5,7-tetramethyl-2,6-di[2-(3,4-epoxycyclohexyl)ethyl]-4,8-dinorbornanylcyclotetrasiloxane; 1,3,5,7-tetramethyl-2,4,6-tri[2-(3,4-epoxycyclohexyl)ethyl]-8-norbornanylcyclotetrasiloxane; and 1,3,5,7-tetramethyl-2,4,6-trinorbornanyl-8-[2-(3,4-epoxycyclohexyl)ethyl]cyclotetrasiloxane. Of these, 1,3,5,7-tetramethyl-2,4-di[2-(3,4-epoxycyclohexyl)ethyl]-6,8-dinorbornanylcyclotetrasiloxane and 1,3,5,7-tetramethyl-2,6-di[2-(3,4-epoxycyclohexyl)ethyl]-4,8-dinorbornanylcyclotetrasiloxane can be preferably used.

There are no limitations on the method for manufacturing the one or more organopolysiloxane of the present invention having a UV-curable functional group and a non-UV-curable monofunctional polycyclic functional group which may contain a hetero atom, and any method commonly used for manufacturing a functional group-containing polysiloxane, specifically, a hydrolysis condensation reaction, a hydrosilylation reaction, an organic functional group conversion reaction, and the like, can be used. Of these, the hydrosilylation reaction is widely applicable, and an intended addition reaction product can be easily prepared by heating a silicon-bonded hydrogen atom-functional polysiloxane and an organic alkenyl compound in the presence of a platinum-based compound catalyst. In the present invention, as one example, a functional polysiloxane having an average of 2 to 10 silicon atoms and two or more silicon-bonded hydrogen atoms can be manufactured by subjecting both 1) a compound having a UV-curable functional group and an alkenyl group, and 2) a compound having an alkenyl group and a non-UV-curable monofunctional polycyclic functional group which may contain a hetero atom to a single-step or multi-step hydrosilylation reaction.

### [Component (B)]

Component (B) is one or more organopolysiloxane having, in each molecule, two or more UV-curable functional groups on average and not having a non-UV-curable monofunctional polycyclic functional group which may contain a hetero atom. By adding this component to the curable composition, it is possible to control the viscosity of the entire composition, and the hardness and elastic modulus of a cured product thereof generated by UV irradiation, to desired property values.

The polysiloxane of component (A) is an organopolysiloxane that is a linear, branched, or cyclic, preferably linear or branched, and particularly preferably linear organopolysiloxane, expressed by the following average compositional formula:

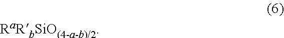

In formula (6),
R¹ represents a UV-curable functional group; and
R′ represents an unsubstituted or fluorine-substituted monovalent hydrocarbon group excluding a UV-curable functional group, a and b being numbers satisfying the following conditions: 1≤a+b≤3 and 0.04≤a/(a+b)≤0.5.

The aforementioned radical polymerizable group and cationic polymerizable group can be applied as the UV-curable functional group represented by R¹ in formula (6). Furthermore, the UV-curable functional group is preferably an epoxy group-containing group. Examples of particularly preferable groups include glycidyloxypropyl groups, epoxycyclohexylalkyl groups, and particularly a 3,4-epoxycyclohexylethyl group. Linear, branched, or cyclic organopolysiloxanes expressed by the average compositional formula above have at least two UV-curable functional groups (R) on average per molecule. The number of UV-curable groups is preferably 2 to 6, more preferably 2 to 4, particularly preferably 2 to 3, and most preferably 2 per molecule on average.

The same groups as above can be applied to the unsubstituted monovalent hydrocarbon group and the fluorine-substituted monovalent hydrocarbon group represented by R′ in formula (6). A methyl group, a phenyl group, or a 3,3,3-trifluoropropyl group is preferred.

The organopolysiloxane expressed by formula (6) has a viscosity at 25° C. of 5 to 1000 mPa·s, 5 to 500 mPa·s, or 5 to 100 mPa·s, but most preferably 5 to 50 mPa·s. The viscosity of the organopolysiloxane can be adjusted by changing the ratio of a and b in formula (6) as well as the molecular weight.

The organopolysiloxane expressed by formula (6) preferably has on average 2 to 10 silicon atoms per molecule, more preferably 2 to 8 atoms, and particularly preferably 2 to 5 atoms.

In one preferred aspect, the organopolysiloxane of component (B) is a compound expressed by the following formula (2′):

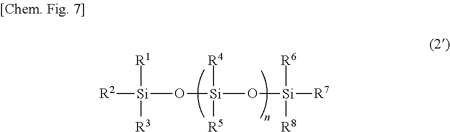

Similar to the compound expressed by formula (6) above, the organopolysiloxane expressed by formula (2′) has on average two or more UV-curable functional groups per molecule. In formula (2′), of all R¹ to R⁸ groups, an average of two or more per molecule are UV-curable functional groups. The groups described above can be used as the UV-curable functional group.

In formula (2′), R¹ to R⁸ other than the UV-curable functional group each independently represent an unsubstituted or fluorine-substituted monovalent hydrocarbon group, and the aforementioned groups can also be applied thereto.

The number of UV-curable functional groups provided by the organopolysiloxane of formula (2′), serving as component (B) is, as a whole, 2 to 6 on average per molecule, preferably 2 to 5, more preferably 2 to 4, particularly preferably 2 to 3, and most preferably 2.

In particular, one of R¹ to R₈ in formula (2′) and one of R₆ to R₈ are preferably UV-curable functional groups. Furthermore, one of R₁ to R₃ in formula (2′) and one of R₆ to R₈ are particularly preferably UV-curable functional groups.

For n in formula (2′), the viscosity of the organopolysiloxane expressed by formula (2′) at 25° C. is preferably 5 to 1000 mPa·s, more preferably 5 to 500 mPa·s, particularly preferably 5 to 100 mPa·s, and most preferably 5 to 50 mPa·s. A person of ordinary skill in the art can easily determine the value of n without excess trial and error such that the viscosity of the organopolysiloxane of formula (2′) is within the aforementioned viscosity range. In general, however, the number of silicon atoms per molecule is preferably 2 to 10, and particularly preferably 2 to 5, in order for the compound of formula (2′) to have the desired viscosity.

The organopolysiloxane of formula (2′) can be used as one type or as a mixture of two or more types. If two or more organopolysiloxanes are used as a mixture, the viscosity of the mixture at 25° C. is preferably the viscosity described above.

Furthermore, the compound of formula (6) above may be an organopolysiloxane expressed by the following average unit formula (3′).

Average unit formula:

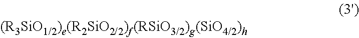

In formula (3′), R each independently represent a group selected from UV-curable functional groups and unsubstituted or fluorine-substituted monovalent hydrocarbon groups; at least two of all R₈ are UV-curable functional groups; (g+h) is a positive number; e is 0 or a positive number; and f is a number in the range of 0 to 10.

The UV-curable functional groups and monovalent hydrocarbon groups are as defined above for formula (6). Furthermore, a preferred viscosity of the organopolysiloxane expressed by formula (3′) is as specified above for the organopolysiloxane expressed by formula (1).

The number of UV-curable functional groups provided by the organopolysiloxane expressed by formula (3′) is preferably 2 to 5, more preferably 2 to 4, particularly preferably 2 to 3, and most preferably 2, per molecule.

The organopolysiloxane expressed by formula (3′) preferably has 4 to 20 silicon atoms per molecule, more preferably 4 to 12 atoms, and particularly preferably 5 to 10 atoms.

Specific examples of the organopolysiloxane expressed by the aforementioned formula (6), and particularly the formula (2′) or (3′), include: 1,3-bis[2-(3,4-epoxycyclohexyl)ethyl]-1,1,3,3-tetramethyldisiloxane; 1,5-bis[2-(3,4-epoxycyclohexyl)ethyl]-1,1,3,3,5,5-hexamethyltrisiloxane; 1,7-bis[2-(3,4-epoxycyclohexyl)ethyl]-1,1,3,3,5,5,7,7-octamethyltetrasiloxane; 1,9-bis[2-(3,4-epoxycyclohexyl)ethyl]-1,1,3,3,5,5,7,7,9,9-decamethylpentasiloxane; methyl(tris[2-(3,4-epoxycyclohexyl)ethyl]dimethylsiloxy) silane; tetrakis([2-(3,4-epoxycyclohexyl)ethyl]dimethylsiloxy) silane; 1,3-bis(3-glycidoxypropyl)-1,1,3,3-tetramethyldisiloxane; 1,5-bis(3-glycidoxypropyl)-1,1,3,3,5,5-hexamethyltrisiloxane; 1,7-bis(3-glycidoxypropyl)-1,1,3,3,5,5,7,7-octamethyltetrasiloxane; 1,9-bis(3-glycidoxypropyl)-1,1,3,3,5,5,7,7,9,9-decamethylpentasiloxane; methyl(tris[3-glycidoxypropyl]dimethylsiloxy) silane; tetrakis([3-glycidoxypropyl]dimethylsiloxy) silane; polydimethylsiloxane capped on both terminals with (3,4-epoxycyclohexylethyldimethylsilyl); polydimethylsiloxane capped on both terminals with (3-glycidoxypropyldimethylsilyl); dimethylsiloxy/(methyl-3,4-epoxycyclohexylethylsiloxy) copolymers capped on both terminals with trimethylsilyl; dimethylsiloxy/(methyl-3-glycidoxypropylsiloxy) copolymers capped on both terminals with trimethylsilyl; dimethylsiloxy/(methyl-3,4-epoxycyclohexylethylsiloxy) copolymers capped on both terminals with (3,4-epoxycyclohexylethyldimethylsilyl); and dimethylsiloxy/(methyl-3-glycidoxypropylsiloxy) copolymers capped on both terminals with (3-glycidoxypropyldimethylsilyl).

Furthermore, the compound of the aforementioned formula (6) may be a cyclic organopolysiloxane expressed by the following formula (5):

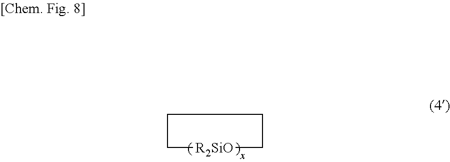

(where R each independently represent a group selected from UV-curable functional groups and unsubstituted or fluorine-substituted monovalent hydrocarbon groups, x is an integer of 3 to 10, and at least two UV-curable functional groups are present in each molecule).

The UV-curable functional group and the unsubstituted or fluorine-substituted monovalent hydrocarbon group, which can be represented by R in formula (5), are as defined for formula (6) above.

Furthermore, a preferred viscosity of the organopolysiloxane expressed by formula (4′) is as specified above for the organopolysiloxane expressed by formula (6).

Specific examples of the cyclic organopolysiloxane expressed by formula (4′) include 1,3,5-trimethyl-1,3,5-tri[2-(3,4-epoxycyclohexyl)ethyl]cyclotrisiloxane, 1,3,5-trimethyl-1,3,5-tri (3-glycidoxypropyl)cyclotrisiloxane, 1,3,5,7-tetramethyl-1,3,5,7-tetra[2-(3,4-epoxycyclohexyl]ethyl]cyclotrisiloxane, 1,3,5,7-tetramethyl-1,3,5,7-tetra(3-glycidoxypropyl)cyclotetrasiloxane, 1,3,5,7,9-pentamethyl-1,3,5,7,9-penta[2-(3,4-epoxycyclohexyl)ethyl]cyclopentasiloxane, and 1,3,5,7,9-pentamethyl-1,3,5,7,9-penta (3-glycidoxypropyl)cyclopentasiloxane.

The organopolysiloxanes expressed by formulas (6) and (2′) to (4′) can each be individually one type, or optionally a combination of two or more types as component (B). Component (B) is particularly preferably one or more organopolysiloxane selected from the group consisting of the aforementioned linear organopolysiloxanes expressed by formula (2′), cyclic organopolysiloxanes expressed by formula (4′), and combinations thereof.

Component (B) is a linear organopolysiloxane having UV-curable functional groups only at both ends of each molecular chain and an average number of silicon atoms in the range of 2 to 5, and particularly preferably a linear dimethylpolysiloxane having epoxy group-containing groups at both ends of each molecular chain.

A compound recommended as component (B) is one compound selected from the group consisting of 1,3-bis[2-(3,4-epoxycyclohexyl)ethyl]-1,1,3,3-tetramethyldisiloxane, 1,5-bis[2-(3,4-epoxycyclohexyl)ethyl]-1,1,3,3,5,5-hexamethyltrisiloxane, 1,9-bis[2-(3,4-epoxycyclohexyl)ethyl]-1,1,3,3,5,5,7,7,9,9-decamethylpentasiloxane, methyl(tris[2-(3,4-epoxycyclohexyl)ethyl]dimethylsiloxy) silane, tetrakis([2-(3,4-epoxycyclohexyl)ethyl]dimethylsiloxy) silane, polydimethylsiloxane capped on both terminals with (3,4-epoxycyclohexylethyldimethylsilyl), or a combination of two or more of these compounds. Of these, 1,3-bis[2-(3,4-epoxycyclohexyl)ethyl]-1,1,3,3-tetramethyldisiloxane is particularly preferably used.

### [Component (C)]

Component (C) is an organosilicon compound having, in each molecule, one UV-curable functional group in an organosilane or organopolysiloxane skeleton and no non-UV-curable monofunctional polycyclic functional groups which may contain a hetero atom. Mainly, an effect is provided in which the crosslinking density of a cured product obtained from the composition of the present invention is controlled, and the physical properties of the cured product are adjusted, particularly the dielectric constant, while simultaneously reducing the viscosity of the composition. Component (C) differs from component (B) in having only one UV-curable functional group in each molecule.

The molecular structure of component (C) is arbitrary so long as the aforementioned object can be achieved. As an example, the organosilicon compound of component (C) is an organosilane expressed by the following average compositional formula:

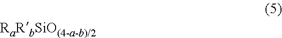

(where R represents a UV-curable functional group;
R′ represents an unsubstituted or fluorine-substituted monovalent hydrocarbon group excluding a UV-curable functional group, a and b are numbers satisfying the following conditions: 1≤a+b≤4 and 0.04≤a/(a+b)≤0.25; and
the number of R in each molecule is 1.) or is a
linear, branched, or cyclic organopolysiloxane.

One selected from the group consisting of these organosilanes and organopolysiloxanes may be used, or any two or more may be used in combination.

As the UV-curable functional group and the unsubstituted or fluorine-substituted monovalent hydrocarbon group represented by R in formula (5), the groups described above can be used.

The viscosity of the organosilicon compound expressed by the aforementioned formula (5) at 25° C. is preferably 1 to 50 mPa·s, more preferably 1 to 20 mPa·s, and particularly preferably 2 to 10 mPa·s. The viscosity of the organosilicon compound can be adjusted by changing the ratio and the molecular weight of a and b in formula (5).

The organosilicon compound expressed by formula (5) is preferably a compound having 1 to 10, and preferably 1 to 4 silicon atoms per molecule.

In one preferred aspect, the organosilicon compound of component (C) is an organopolysiloxane compound expressed by the following formula (2″):

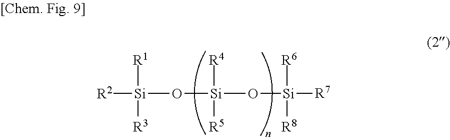

Similar to the compound expressed by formula (2′) above, in the organopolysiloxane expressed by formula (2″), only one of all R¹ to R⁸ is a UV-curable functional group.

Similar to the compound expressed by formula (2′) above, the UV-curable functional group may be the same as the groups described above.

There is no limitation to the position of the UV-curable functional group in the organopolysiloxane expressed by formula (2″), and a molecular end group, in other words, one of R₁ to R₈ or one of R₆ to R₈, may be a UV-curable functional group. Moreover, a non-end group, in other words, one of R₄ and R₅ in formula (2″), can be a UV-curable functional group.

For n in formula (2″), the viscosity of the organopolysiloxane expressed by formula (2″) above at 25° C. is preferably 1 to 50 mPa·s, more preferably 1 to 20 mPa·s, and particularly preferably 2 to 10 mPa·s. A person of ordinary skill in the art can easily determine the value of n without excess trial and error such that the viscosity of the organopolysiloxane of formula (2″) is within the aforementioned viscosity range. In general, the number of silicon atoms per molecule is preferably 2 to 10, and particularly preferably between 2 to 4, in order for the compound of formula (2″) to have the desired viscosity.

The organopolysiloxane of formula (2″) can be used as one type or as a mixture of two or more types. If a mixture of two or more organopolysiloxanes are used as a mixture, the viscosity of the mixture at 25° C. is 1 to 50 mPa·s, preferably 1 to 20 mPa·s, and more preferably 2 to 10 mPa·s.

Specific examples of organopolysiloxanes having one UV-curable functional group in each molecule, which are expressed by formula (2″), include 1-[2-(3,4-epoxycyclohexyl)ethyl]-1,1,3,3,3-pentamethyldisiloxane, 1-[2-(3,4-epoxycyclohexyl)ethyl]-1,1,3,3,5,5,5-heptamethyltrisiloxane, 3-[2-(3,4-epoxycyclohexyl)ethyl]-1,1,1,3,5,5,5-heptamethyltrisiloxane, and 1-[2-(3,4-epoxycyclohexyl)ethyl]-1,1,3,3,5,5,7,7,7-nonamethyltetrasiloxane, 1-(3-glycidoxypropyl)-1,1,3,3,3-pentamethyldisiloxane, 1-(3-glycidoxypropyl)-1,1,1,3,3,5,5,5-heptamethyltrisiloxane, 3-(3-glycidoxypropyl)-1,1,1,3,5,5,5-heptamethyltrisiloxane, and 1-(3-glycidoxypropyl)-1,1,3,3,5,5,7,7,7-nonamethyltetrasiloxane.

Furthermore, the aforementioned organosilicon compound of formula (5) above may be a cyclic organopolysiloxane expressed by the following formula (4″).

Formula:

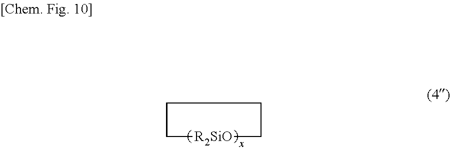

In formula (4″), R each independently represent a group selected from UV-curable functional groups and unsubstituted or fluorine-substituted monovalent hydrocarbon groups; x is an integer of 3 to 5; and only one UV-curable functional group is provided in each molecule.

The UV-curable functional groups and monovalent hydrocarbon groups are as defined above for formula (5).

A preferred viscosity of the cyclic organopolysiloxane expressed by formula (4″) is as specified above for the organopolysiloxane expressed by formula (5). Therefore, the viscosity at 25° C. is preferably 1 to 50 mPa·s, more preferably 1 to 20 mPa·s, and particularly preferably 2 to 10 mPa·s.

Specific examples of the cyclic organopolysiloxanes expressed by formula (4″) include [2-(3,4-epoxycyclohexyl)ethyl]-pentamethylcyclotrisiloxane, [2-(3,4-epoxycyclohexyl)ethyl]-heptamethylcyclotetrasiloxane, [2-(3,4-epoxycyclohexyl)ethyl]-nonamethylcyclopentasiloxane, 3-glycidoxypropyl-pentamethylcyclotrisiloxane, 3-glycidoxypropyl-heptamethylcyclotetrasiloxane, and 3-glycidoxypropyl-nonamethylcyclopentasiloxane.

Furthermore, component (C) may be an organosilane expressed by the following formula (5″).

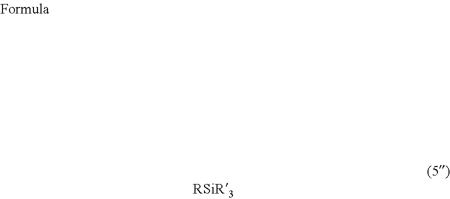

In formula (5″), R represents a UV-curable functional group, and R′ is an unsubstituted or fluorine-substituted monovalent hydrocarbon group other than a UV-curable functional group.

The UV-curable functional groups and monovalent hydrocarbon groups are as defined above for formula (5).

Furthermore, a preferred viscosity of the organosilane expressed by formula (5″) is the same as the aforementioned viscosity specified for the organopolysiloxane expressed by formula (5). Therefore, the viscosity at 25° C. is preferably 1 to 50 mPa·s, more preferably 1 to 20 mPa·s, and particularly preferably 2 to 10 mPa·s.

Specific examples of organosilanes expressed by formula (5″) include [2-(3,4-epoxycyclohexyl)ethyl]triethylsilane, [2-(3,4-epoxycyclohexyl)ethyl]dimethylphenylsilane, [2-(3,4-epoxycyclohexyl)ethyl]dimethyloctylsilane, [2-(3,4-epoxycyclohexyl)ethyl]dimethylcyclohexylsilane, [2-(3,4-epoxycyclohexyl)ethyl]trihexylsilane, [2-(3,4-epoxycyclohexyl)ethyl]tributylsilane, 3-glycidoxypropyltriethylsilane, 3-glycidoxypropyl dimethylphenylsilane, 3-glycidoxypropyl dimethyloctylsilane, 3-glycidoxypropyl dimethylcyclohexylsilane, 3-glycidoxypropyl trihexylsilane, and 3-glycidoxypropyl tributylsilane.

The organosilicon compounds expressed by formulas (5), (2″), (4″), and (5″) can be used individually or optionally in a combination of two or more types. In other words, the organosilicon compounds expressed by formula (5), (2″), (4″), or (5″), and mixtures of two or more compounds arbitrarily selected therefrom can be used as component (C) of the composition of the present invention.

As component (C), an organosilicon compound selected from organopolysiloxanes expressed by formula (2″), cyclic organopolysiloxanes expressed by formula (4″), and combinations thereof can be preferably used. In particular, component (C) is an organopolysiloxane having an average number of silicon atoms of three or more and having one UV-curable functional group in each molecule, and the number of silicon atoms is particularly preferably 3 or 4.

Component (C) is particularly preferably 1,1,1,3,5,5,5-heptamethyl-3-[2-(3,4-epoxycyclohexyl)ethyl]trisiloxane.

### [Amount of Components (B) and (C) Used]

In the UV-curable composition of the present invention, in addition to component (A) as an essential component, components (B) and (C) can be used at an arbitrary mass ratio. The amount of component (B) used relative to the entire UV-curable composition is 0 mass % or more and 90 mass % or less, preferably 0 mass % or more and 60 mass % or less, and more preferably 10 mass % or more and 50 mass % or less. Similarly, the amount of component (C) used is 0 mass % or more and 50 mass % or less, preferably 0 mass % or more and 45 mass % or less, and more preferably 10 mass % or more and 45 mass % or less. By increasing the amount of component (B) used in the composition, the hardness of the cured product after curing tends to increase. Meanwhile, by increasing the amount of component (C) used in the composition, the viscosity of the composition decreases, and the hardness of the cured product after curing tends to decrease. From the perspective of suitably achieving the object of the present invention, the amount of component (A) is preferably more than 15 mass %, and more preferably more than 30 mass %, relative to the total amount of the curable composition. By appropriately adjusting the usage ratios of components (A), (B), and (C), it is possible to adjust the viscosity of the curable composition and to design a material of the obtained cured product, which has increased mechanical properties, particularly hardness, and a low dielectric constant.

In the UV-curable composition of the present invention, in addition to the aforementioned components (A), (B), and (C), a component (D), which does not contain silicon atoms and can be cured by ultraviolet rays, can be used in order to adjust the physical properties of the cured product. As component (D), a compound capable of undergoing photocationic polymerization is preferred. Specific examples include epoxy group-containing compounds, oxetane group-containing compounds, and vinyl ether group-containing compounds, with epoxy group-containing compounds being preferred. There is no limitation on the number of epoxy groups in each molecule, but in consideration of availability and the effect on the viscosity of the curable composition, a compound having one or two epoxy groups in each molecule is preferred, with a compound having two epoxy groups being more preferred.

Specific examples include glycidyl phenyl ether, benzyl glycidyl ether, 2-ethylhexyl glycidyl ether, ethylene glycol diglycidyl ether, neopentyl glycol diglycidyl ether, 1,4-butanediol diglycidyl ether, bisphenol A diglycidyl ether, 1,7-octadiene diepoxide, limonene oxide, 3,3′-3,4-epoxycyclohexylmethyl-3′,4′-bi-7-oxabicyclo[4,1,0]heptane, epoxycyclohexanecarboxylate, and 1,2:5,6-diepoxyhexahydroindan. 1,7-octadiene diepoxide is preferably used.

### [Overall Viscosity of the Composition]

The curable composition of the present invention can be used as a coating agent, and the viscosity of the entire composition is preferably 500 mPa's or less at 25° C., as measured using an E-type viscometer, in order for the composition to have suitable flowability and workability for coating to a base material. A more preferred viscosity range is 5 to 80 mPa·s, even more preferably 5 to 40 mPa·s, and particularly preferably 5 to 30 mPa·s. The viscosity of the entire curable composition can be adjusted to the desired viscosity by using compounds with a preferred viscosity as each component so that the viscosity of the entire composition has the desired viscosity.

### [Organic Solvent-Free]

The UV-curable composition of the present invention can achieve a suitable viscosity for a coating agent without substantial use of an organic solvent by using each of the aforementioned components, and the UV-curable composition preferably substantially does not include an organic solvent. In the present specification, the phrase “essentially not containing an organic solvent” means that the amount of organic solvent is less than 0.05 mass % of the total composition, preferably less than or equal to the analytical limit of analytical methods such as gas chromatography or the like. In the present invention, the desired viscosity can be achieved without the use of organic solvents by adjusting the molecular structure and molecular weight of component (A), component (B), and component (C).

### [Photopolymerization Initiator]

In addition to the components (A), (B), and (C) above, a photopolymerization initiator can be added to the UV-curable composition of the present invention if desired. In this case, when the UV-curable functional group provided by components (A), (B), and (C) is a cationic polymerizable functional group containing epoxy, vinylether, or the like, a photocationic polymerization initiator is used as the photopolymerization initiator. Well known photocationic polymerization initiators include compounds that can generate Bronsted acids or Lewis acids by UV irradiation or electron beam irradiation, and are so-called photoacid generators, and it is known that irradiation of ultraviolet rays or the like generates an acid, which causes a reaction between cationic polymerizable functional groups. Furthermore, when the UV-curable functional group is a radical polymerizable functional group, a photoradical polymerization initiator can be used as the photopolymerization initiator. The photoradical polymerization initiator generates free radicals by irradiating ultraviolet rays or electron beams, which trigger a radical polymerization reaction, to cure the composition of the present invention. When the composition of the present invention is cured by electron beam irradiation, a polymerization initiator is normally not required.

### (1) Photocationic Polymerization Initiator

The photocationic polymerization initiator used in the curable composition of the present invention can be selected from any known in the technical field and is not limited to any particular one. Strong acid-generating compounds, such as diazonium salts, sulfonium salts, iodonium salts, phosphonium salts, and the like, are known as photocationic polymerization initiators, and these can be used. Examples of photocationic polymerization initiators include, but are not limited to, bis(4-tert-butylphenyl) iodonium hexafluorophosphate, cyclopropyldiphenylsulfonium tetrafluoroborate, dimethylphenacylsulfonium tetrafluoroborate, diphenyliodonium hexafluorophosphate, diphenyliodonium hexafluoroarsenate, diphenyliodonium tetrafluoromethanesulfonate, 2-(3,4-dimethoxystyryl)-4,6-bis(trichloromethyl)-1,3,5-triazine, 2-[2-(furan-2-yl)vinyl]-4,6-bis(trichloromethyl)-1,3,5-triazine, 4-isopropyl-4′-methyldiphenyliodonium tetrakis(pentafluorophenyl) borate, 2-[2-(5-methylfuran-2-yl)vinyl]-4,6-bis(trichloromethyl)-1,3,5-triazine, 2-(4-methoxyphenyl)-4,6-bis(trichloromethyl)-1,3,5-triazine, 2-(4-methoxystylyl)-4,6-bis(trichloromethyl)-1,3,5-triazine, 4-nitrobenzenediazonium tetrafluoroborate, triphenylsulfonium tetrafluoroborate, triphenylsulfonium bromide, tri-p-tolylsulfonium hexafluorophosphate, tri-p-tolylsulfonium trifluoromethanesulfonate, diphenyliodonium triflate, triphenylsulfonium triflate, diphenyliodonium nitrate, bis(4-tert-butylphenyl) iodonium perfluoro-1-butane sulfonate, bis(4-tert-butylphenyl) iodonium triflate, triphenylsulfonium perfluoro-1-butanesulfonate, N-hydroxynaphthalimide triflate, p-toluene sulfonate, diphenyliodonium p-toluenesulfonate, (4-tert-butylphenyl)diphenylsulfonium triflate, tris(4-tert-butylphenyl) sulfonium triflate, N-hydroxy-5-norbornene-2,3-dicarboxymide perfluoro-1-butanesulfonate, (4-phenylthiophenyl)diphenylsulfonium triflate, 4-(phenylthio) phenyldiphenylsulfonium triethyltrifluorophosphate, and the like. In addition to the aforementioned compounds, examples of photocationic polymerization initiators can include Omnicat 250, Omnicat 270 (produced by IGM Resins B.V.), CPI-310B, IK-1 (produced by San-Apro Ltd.), DTS-200 (produced by Midori Kagaku Co., Ltd.), and Irgacure 290 (produced by BASF), and other commercially available photoinitiators.

The amount of the photocationic polymerization initiator added to the curable composition of the present invention is not particularly limited so long as a desired photocuring reaction occurs, but in general, the photocationic polymerization initiator is preferably used at an amount of 0.1 to 10 mass %, preferably 0.2 to 5 mass %, and particularly preferably 0.5 to 4 mass % with respect to the total amount of components (A), (B), and (C) of the present invention.

When the UV-curable functional groups of components (A), (B), and (C) are a photocationic polymerization initiator such as an epoxy group or the like, a photoradical polymerization initiator described below can be used in addition to the photocationic polymerization initiator described above as a polymerization initiator. The curability of the UV-curable organopolysiloxane composition may be improved by using both initiators together.

### (2) Photoradical Polymerization Initiator

The photoradical polymerization initiators are known to be broadly classified into photo-fragmentation and hydrogen abstraction types. However, the photoradical polymerization initiator used in the composition of the present invention can be arbitrarily selected from those known in the technical field, and is not limited to any particular one. Examples of photoradical polymerization initiators include, but are not limited to, acetophenone, p-anisyl, benzyl, benzoin, benzophenone, 2-benzoylbenzoic acid, 4,4′-bis(diethylamino) benzophenone, 4,4′-bis(dimethylamino) benzophenone, benzoin methyl ether, benzoin isopropyl ether, benzoin isobutyl ether, benzoin ethyl ether, 4-benzoylbenzoic acid, 2,2′-bis(2-chlorophenyl)-4,4′,5,5′-tetraphenyl-1,2′-biimidazole, methyl 2-benzoylbenzoate, 2-(1,3-benzodioxol-5-yl)-4,6-bis(trichloromethyl)-1,3,5-triazine, 2-benzyl-2-(dimethylamino)-4′-morpholinobutyrophenone, (+)-camphorquinone, 2-chlorothioxanthone, 4,4′-dichlorobenzophenone, 2,2-diethoxyacetophenone, 2,2-dimethoxy-2-phenylacetophenone, 2,4-diethylthioxanthene-9-one, diphenyl(2,4,6-trimethylbenzoyl) phosphine oxide, ethyl(2,4,6-trimethylbenzoyl) phenyl phosphinate, 1,4-dibenzoylbenzene, 2-ethylanthraquinone, 1-hydroxycyclohexylphenyl ketone, 2-hydroxy-2-methylpropiophenone, 2-hydroxy-4′-(2-hydroxyethoxy)-2-methylpropiophenone, 2-isopropylthioxanthone, lithium phenyl(2,4,6-trimethylbenzoyl) phosphinate, 2-methyl-4′-(methylthio)-2-morpholinopropiophenone, 2-isonitrosopropiophenone, 2-phenyl-2-(p-toluenesulfonyloxy) acetophenone, and phenylbis(2,4,6-trimethylbenzoyl) phosphine oxide, and the like. Furthermore, in addition to the aforementioned compounds, examples of the photoradical polymerization initiators can include Omnirad (registered trademark) 651, 184, 1173, 2959, 127, 907, 369, 369E, and 379EG (alkylphenone photopolymerization initiator, IGM Resins B.V.), Omnirad (registered trademark) TPO H, TPO-L, and 819 (acyl phosphine oxide photopolymerization initiator, IGM Resins B.V.), Omnirad (registered trademark) MBF and 754 (intramolecular hydrogen extraction type photopolymerization initiator, IGM Resins B.V.), Irgacure (registered trademark) OXE01 and OXE02 (oxime ester non-associative polymerization initiator, BASF), and the like.

While the amount of the photoradical polymerization initiator added to the composition of the present invention is not particularly limited so long as the intended photoradical polymerization reaction or photocuring reaction occurs, it is generally used at an amount of 0.01 to 5 mass %, and preferably 0.05 to 1 mass % relative to the total mass of the composition of the present invention.

Moreover, a photosensitizer may be used in combination with the photocationic polymerization initiator or the photoradical polymerization initiator. Use of a sensitizer can increase the photon efficiency of the polymerization reaction, and is particularly effective when the coating thickness of the composition is relatively thick or when a relatively long-wavelength LED light source is used, because use of longer wavelength light for the polymerization reaction compared to only using a photoinitiator is feasible. While not limited thereto, examples of known sensitizers include anthracene-based compounds, phenothiazine-based compounds, perylene-based compounds, cyanine-based compounds, melocyanine-based compounds, coumarin-based compounds, benzylidene ketone-based compounds, and (thio) xanthene- or (thio) xanthone-based compounds such as isopropylthioxanthone, 2,4-diethylthioxanthone, alkyl-substituted anthracenes, squarylium-based compounds, (thia) pyrylium-based compounds, porphyrin-based compounds, and the like, with an arbitrary photosensitizer capable of being used in the curable composition according to the present invention.

The cured product obtained from the curable composition of the present invention can be designed such that desired physical properties of the cured product and the curing rate of the curable composition are obtained and the viscosity of the curable composition is a desired value, depending on the molecular chain lengths of component (A), component (B) and component (C), the position of the UV-curable functional group in each molecule, the molecular structure, and the number of UV-curable functional groups per molecule of component (A). Furthermore, the cured product obtained by curing the curable composition of the present invention is also included in the scope of the present invention. Furthermore, the shape of the cured product obtained from the composition of the present invention is not particularly limited, and it may be a thin film coating layer, may be a sheet-like molded product or the like, may be injected into a specific site in an uncured state and then cured to form a filling material, or may be used as a sealing material for a laminated body, display device, or the like or as an intermediate layer. The cured product obtained from the composition of the present invention is particularly preferably in the form of a thin film coating layer, and is particularly preferably an insulative coating layer.

The curable composition of the present invention is suitably used as a coating agent or potting agent, particularly as an insulative coating agent or potting agent for an electronic device or electrical device.

The cured product obtained by curing the curable composition of the present invention is characterized by low dielectric properties, and particularly a low dielectric constant. When a test body having a thickness of 1 mm is used and evaluated at 25° C. and a frequency of 100 kHz, the dielectric constant is usually 2.7 or less. By optimizing the curable composition, the dielectric constant of the cured product can be 2.5 or less. Thus, the material is useful for forming a coating layer having a low dielectric constant, and particularly as a material for forming a layer for a flexible display.

### [Other Additives]

Another additive may be added to the composition of the present invention if desired. Examples of additives that can be used include leveling agents, adhesion-imparting agents described below, silane coupling agents not included in those normally used as adhesion-imparting agents, UV absorbers, antioxidants, polymerization inhibitors, fillers (reinforcing fillers, insulating fillers, thermal conductive fillers, and other functional fillers), and the like. If necessary, an appropriate additive can be added to the composition of the present invention. Furthermore, a thixotropy imparting agent may also be added to the composition of the present invention if necessary, particularly when used as a potting agent or sealing material. In particular, the following adhesion-imparting agent may be and is preferably optionally added to the composition of the present invention.

### [Adhesion-Imparting Agent]

An adhesion promoter can be added to the composition of the present invention to improve adhesion and close-fitting properties to a base material in contact with the composition. When the curable composition of the present invention is used for applications such as coating agents, sealing materials, and the like that require adhesion or close-fitting properties to a base material, an adhesion-imparting agent is preferably added to the curable composition of the present invention. An arbitrary known adhesion promoter can be used, so long as the adhesion promoter does not interfere with a curing reaction of the composition of the present invention.

Examples of such adhesion promoters that can be used in the present invention include: organosilanes having a trialkoxysiloxy group (such as a trimethoxysiloxy group or a triethoxysiloxy group) or a trialkoxysilylalkyl group (such as a trimethoxysilylethyl group or triethoxysilylethyl groups) and a hydrosilyl group or an alkenyl group (such as a vinyl group or an allyl group), or organosiloxane oligomers having a linear structure, branched structure, or cyclic structure with approximately 4 to 20 silicon atoms; organosilanes having a trialkoxysiloxy group or a trialkoxysilylalkyl group and a methacryloxyalkyl group (such as a 3-methacryloxypropyl group), or organosiloxane oligomers having a linear structure, branched structure, or cyclic structure with approximately 4 to 20 silicon atoms; organosilanes having a trialkoxysiloxy group or a trialkoxysilylalkyl group and an epoxy group-bonded alkyl group (such as a 3-glycidoxypropyl group, a 4-glycidoxybutyl group, a 2-(3,4-epoxycyclohexyl) ethyl group, or a 3-(3,4-epoxycyclohexyl) propyl group), or organosiloxane oligomers having a linear structure, branched structure, or cyclic structure with approximately 4 to 20 silicon atoms; organic compounds having two or more trialkoxysilyl groups (such as trimethylsilyl groups or triethoxysilyl groups); reaction products of aminoalkyltrialkoxysilane and epoxy group-bonded alkyltrialkoxysilane, and epoxy group-containing ethyl polysilicate. Specific examples thereof include vinyl trimethoxysilane, allyl trimethoxysilane, allyl triethoxysilane, hydrogen triethoxysilane, 3-glycidoxypropyl trimethoxysilane, 3-glycidoxypropyl triethoxysilane, 2-(3,4-epoxycyclohexyl) ethyl trimethoxysilane, 3-methacryloxypropyl trimethoxysilane, 3-methacryloxypropyl triethoxysilane, 1,6-bis(trimethoxysilyl) hexane, 1,6-bis(triethoxysilyl) hexane, 1,3-bis[2-(trimethoxysilyl)ethyl]-1,1,3,3-tetramethyldisiloxane, reaction products of 3-glycidoxypropyl triethoxysilane and 3-aminopropyl triethoxysilane, condensation reaction products of a methylvinyl siloxane oligomer blocked with a silanol group and a 3-glycidoxypropyl trimethoxysilane, condensation reaction products of a methylvinyl siloxane oligomer blocked with a silanol group and a 3-methacryloxypropyl triethoxysilane, and tris(3-trimethoxysilylpropyl) isocyanurate.

The amount of the adhesion promoter to be added to the UV-curable composition of the present invention is not particularly limited. However, since it does not promote curing properties of the curable composition or discoloration of a cured product, the amount is preferably in the range of 0.01 to 5 parts by mass, or in the range of 0.01 to 2 parts by mass, relative to a total of 100 parts by mass of component (A).

### [Application]

The UV-curable organopolysiloxane composition of the present invention can be cured not only by ultraviolet rays but also by electron beams, which is another aspect of the present invention.

The curable composition of the present invention has low viscosity, and is particularly useful as a material for forming an insulating layer for various articles, particularly electronic and electrical devices. The composition of the present invention can be coated on a base material or sandwiched between two base materials, at least one of which includes a material that allows ultraviolet rays or electron beams to pass, and the composition can be cured by irradiating ultraviolet rays or electron beams to form an insulating layer. In this case, the composition of the present invention can be patterned when coated on a base material, and then the composition can be cured. Alternatively, the composition can be coated on a base material, and cured and uncured portions can be left during curing by ultraviolet rays or electron beam irradiation. Thereafter, an uncured portion can be removed with a solvent to form an insulating layer having a desired pattern. In particular, when the cured layer of the present invention is an insulating layer, the layer can be designed to have a low dielectric constant of less than 2.7.

The curable composition of the present invention provides favorable transparency of the cured product obtained therefrom, and is particularly suitable as a material for forming an insulating layer for touch panels, displays and other display devices. In this case, an arbitrary desired pattern may be formed as described above if necessary on the insulating layer. Therefore, a display device such as touch panel, display, or the like containing an insulating layer obtained by curing the UV-curable organopolysiloxane composition of the present invention is also an aspect of the present invention.

Furthermore, the curable composition of the present invention can also be used to form an insulating coating layer (insulating film) by curing after coating an article. Therefore, the composition of the present invention can be used as an insulative coating agent. Furthermore, a cured product formed by curing the curable composition of the present invention can be used as an insulative coating layer.

An insulating film formed from the curable composition of the present invention can be used for various applications. In particular, use is possible as a component of an electronic device or as a material used in a process of manufacturing the electronic device.

Electronic devices include semiconductor devices, magnetic recording heads, and other electronic apparatuses. For example, the curable composition of the present invention can be used in an insulating film of a semiconductor device, such as an LSI, system LSI, DRAM, SDRAM, RDRAM, D-RDRAM, or a multi-chip module multilayer circuit board, an interlayer insulating film for a semiconductor, an etch stopper film, a surface protection film, a buffer coat film, a passivation film in LSI, a cover coat for a flexible copper cladding plate, a solder resistant film, and a surface protection film for an optical device.

Furthermore, the UV-curable composition of the present invention can be used as a coating agent, or as a potting agent, and particularly as an insulative potting agent for electronic devices and electrical devices.

The composition of the present invention can be used as a material for forming a coating layer on a surface of a base material, particularly using an inkjet printing method. In this case, the composition of the present invention particularly preferably contains a surfactant and/or a wettability improving agent.

The present invention is further described below on the basis of Examples, but the present invention is not limited to the Examples below.

### EXAMPLES

The UV-curable composition of the present invention and a cured product thereof will be described in further detail using examples. Furthermore, measurements and evaluations in the examples and comparative examples were performed in accordance with the following techniques.

[Example S1: Synthesis of organopolysiloxane (A1) having a UV-curable functional group and a non-UV-curable monofunctional polycyclic functional group which may contain hetero atoms]

100 g of 1-[2-(3,4-epoxycyclohexyl)ethyl]-1,1,3,3-tetramethyldisiloxane, 38 g of 2-norbornene, 20 mL of heptane, and 8 mg of a platinum (0)-1,3-divinyltetramethyldisiloxane complex (platinum amount: 4.5 mass %) were introduced into a 200 mL three-neck flask, and the mixture was stirred at room temperature for 30 minutes and then at 60° C. for two hours to complete the reaction. Volatile components were removed under reduced pressure to obtain 135 g of a colorless liquid product. From the results of IR and NMR spectroscopic analyses, the product was confirmed as 1-[2-(3,4-epoxycyclohexyl)ethyl]-3-norbornanyl-1,1,3,3-tetramethyldisiloxane (A1). The viscosity at 25° C. was 25.6 mPa·s.

### Example S2: Synthesis of Organopolysiloxane (A2) Having a UV-Curable Functional Group and a Non-UV-Curable Monofunctional Polycyclic Functional Group which May Contain Hetero Atoms

120 g of tetrakisdimethylsiloxysilane, 20 g of 2-norbornene, 67 mg of a platinum (0)-1,3-divinyltetramethyldisiloxane complex (platinum amount: 4.5 mass %), 20 g of 2-norbornene, and 30 mg of dibutylhydroxytoluene were introduced into a 500 mL three-neck flask. A mixture of 75 g of 2-norbornene and 90.5 g of 1,2-epoxy-4-vinylcyclohexane was added dropwise at a bath temperature of 60° C. while controlling an exothermic reaction. The bath temperature was set to 95° C., and the mixture was stirred for 15 hours to complete the reaction. Volatile components were removed under reduced pressure to obtain 278 g of a colorless liquid product. From the results of IR and NMR spectroscopic analyses, the product was confirmed as bis[2-(3,4-epoxycyclohexyl)ethyl]dimethylsiloxy-bisnorbornanyl dimethylsiloxysilane (A2). The viscosity at 25° C. was 206 mPa·s.

### [Viscosity of Component (A) or Curable Composition]

The viscosity (mPa·s) of component (A) or the composition at 25° C. was measured using a rotational viscometer (E-type viscometer TV-25, manufactured by Toki Sangyo Co., Ltd.).

### [Appearance of Curable Composition and Cured Product Obtained Therefrom]

The appearance of the curable composition and cured product obtained therefrom were observed and visually evaluated.

### [Preparation of Curable Composition]

Each material at the amounts listed in Table 1 below was placed in a brown plastic container and mixed well, using a planetary mixer to prepare the curable composition.

[Curing of Curable Composition]0.5 mL of the composition according to each experimental example was placed on a 40×40 mm glass plate. Spin coating was performed at 500 rpm for 10 seconds using a spin coater MS-B150 manufactured by Mikasa Co., Ltd., to obtain a uniform coating. This was introduced into an oven heated to 100° C. and heated for 10 minutes to remove organic solvents. The resulting coating was irradiated with an LED light having a wavelength of 405 nm at an energy amount of 2 J/cm², whereby the composition was cured and a uniform transparent thin film having dimensions of 40×40×0.001 (thickness) mm³ was obtained.

### [Curing of Curable Composition and Preparation of Dynamic Viscoelastic Test Piece]

A PET film coated with a fluoropolymer-based release agent was placed on a glass substrate, a spacer having a thickness of 1.0 mm was placed on top of the PET film, and the PET film and glass substrate were then placed on top of each other in the same manner to form a simple mold. Approximately 0.55 g of the curable composition was injected between the two sandwiched PET films. The composition was cured by irradiating LED light of 405 nm wavelength at an energy level of 2 J/cm² through a glass substrate from the outside to prepare a 10×50×1.0 (thickness) mm³ strip-like test piece.

### [Measurement of Dynamic Viscoelasticity of Organopolysiloxane Cured Product]

A strip-like test piece prepared from the organopolysiloxane cured product was subjected to a viscoelasticity measurement in a temperature range from −40° C. to 160° C. using an MCR-302 dynamic viscoelasticity measuring device manufactured by Anton Paar under conditions of a frequency of 1 Hz, strain of 0.1%, stress of −0.1 N/mm², and a temperature increase rate 3° C./min, and the value of the storage elastic modulus (unit: Pa) at 70° C. was recorded.

### [Curing of Curable Composition and Preparation of Dielectric Constant Test Piece]

A PET film coated with a fluoropolymer-based release agent was placed on a glass substrate, a 1-mm-thick spacer having a circular hole with an inner diameter of 40 mm was placed on top of the PET film, and the PET film and glass substrate were then placed on top of each other in the same manner to form a simple mold. Approximately 1.3 g of the curable composition was injected between the two sandwiched PET films. The composition was cured via irradiation with an LED light having a wavelength of 405 nm at an energy amount of 2 J/cm² from the outer side through one of the glass substrates, thereby preparing a disc-shaped organopolysiloxane cured product having a diameter of 40 mm and a thickness of 1 mm.

### [Dielectric Constant of Organopolysiloxane Cured Product]

A tin foil having a diameter of 33 mm and a thickness of 0.007 mm was pressed onto both surfaces of the prepared organopolysiloxane cured product. In order to improve close-fitting properties between the cured product and the foil, a small amount of silicone oil, if necessary, was used for pressing. The capacitance at room temperature and 100 KHz was measured by an E4990A precision impedance analyzer manufactured by Keysight Technologies to which a parallel plate electrode having a diameter of 30 mm was connected. The dielectric constant was calculated using measured capacitance values, separately measured thicknesses of the cured product, and electrode area values.

### Examples and Comparative Examples

The UV-curable compositions were prepared at the compositions (parts by mass) shown in Table 1 using each of the following components.
(A1) 1-[2-(3,4-epoxycyclohexyl)ethyl]-3-norbornanyl-1,1,3,3-tetramethyldisiloxane
(A2) Bis[2-(3,4-epoxycyclohexyl)ethyl]dimethylsiloxy-bisnorbornanyl dimethylsiloxysilane
(B1) 1,3-bis[2-(3,4-epoxycyclohexyl)ethyl]-1,1,3,3-tetramethyldisiloxane
(B2) 1,3-bis(3-glycidoxypropyl)-1,1,3,3-tetramethyldisiloxane
(B3) Tetrakis[2-(3,4-epoxycyclohexyl)ethyl]dimethylsiloxysilane
(C) 1,1,1,3,5,5,5-heptamethyl-3-[2-(3,4-epoxycyclohexyl)ethyl]trisiloxane
(D) 1,7-octadiene diepoxide
(E1) 4-isopropyl-4′-methyldiphenyliodonium tetrakis(pentafluorophenyl) borate
(E2) 2-isopropylthioxanthone
(F) Propylene glycol methyl ether acetate

TABLE 1

| | Exam- | Exam- | Exam- | Exam- | Exam- | Exam- | Exam- | Exam- | Exam- | Comparative | Comparative |
|---|---|---|---|---|---|---|---|---|---|---|---|
| Component | ple 1 | ple 2 | ple 3 | ple 4 | ple 5 | ple 6 | ple 7 | ple 8 | ple 9 | Example 1 | Example 2 |
| (A1) | | 15.0 | 39.9 | 31.5 | 26.1 | 26.6 | | | | | |
| (A2) | 30.0 | | | | | | 99.5 | 49.1 | 29.5 | | |
| (B1) | | 84.5 | 59.6 | 23.9 | 58.1 | 57.8 | | | 19.6 | 99.5 | |
| (B2) | | | | | | 15.1 | | | | | |
| (B3) | | | | | | | | | | | 99.5 |
| (C) | | | | 44.1 | | | | 50.4 | 50.4 | | |
| (D) | | | | | 15.3 | | | | | | |
| (E1) | 0.50 | 0.50 | 0.50 | 0.50 | 0.50 | 0.50 | 0.50 | 0.50 | 0.50 | 0.50 | 0.50 |
| (E2) | 0.04 | 0.04 | 0.04 | 0.04 | 0.04 | 0.04 | 0.04 | 0.04 | 0.04 | 0.04 | 0.04 |
| (F) | 69.5 | | | | | | | | | | |
| Total | 100.0 | 100.0 | 100.0 | 100.0 | 100.0 | 100.0 | 100.0 | 100.0 | 100.0 | 100.0 | 100.0 |
| Appearance of | Clear | Clear | Clear | Clear | Clear | Clear | Clear | Clear | Clear | Clear | Clear |
| curable | | | | | | | | | | | |
| composition | | | | | | | | | | | |
| Appearance of | Clear | Clear | Clear | Clear | Clear | Clear | Clear | Clear | Clear | Clear | Clear |
| cured product | | | | | | | | | | | |
| Viscosity of | 4 | 35 | 37 | 17 | 18 | 27 | 185 | 26 | 20 | 34 | 440 |
| composition | | | | | | | | | | | |
| Elastic modulus | — | 180 | 64 | 4 | 160 | 74 | 29 | 6 | 10 | 300 | 360 |
| of cured | | | | | | | | | | | |
| product (MPa) | | | | | | | | | | | |
| Dielectric | — | 2.6 | 2.4 | 2.5 | 2.5 | 2.5 | 2.7 | 2.4 | 2.5 | 3.0 | 3.2 |
| constant of | | | | | | | | | | | |
| cured product | | | | | | | | | | | |

As shown in Table 1, the UV-curable compositions of the present invention (Examples 1 to 9) have viscosities at 25° C. suitable for coating onto a base material as a coating agent, particularly for coating by inkjet printing, and have high UV curability. Furthermore, the cured products derived from the composition of the present invention have high transparency. Furthermore, the cured products of the present invention (Examples 2 to 9) have a very low dielectric constant and excellent insulating properties compared to the cured products obtained from compositions not containing component (A) (Comparative Examples 1 and 2).

### Industrial Applicability

The UV-curable composition of the present invention is particularly suitable for the applications described above, and particularly as a material for forming an insulating layer for touch panels and displays and other display devices, and particularly flexible displays.

1. One or more organopolysiloxane comprising, in each molecule: a UV-curable functional group; and a non-UV-curable monofunctional polycyclic functional group which may contain a hetero atom.

2. A UV-curable composition comprising one or more organopolysiloxane (A) having, in each molecule: a UV-curable functional group; and a non-UV-curable monofunctional polycyclic functional group which may contain a hetero atom.

3. The UV-curable composition according to claim 2, comprising one or more of the organopolysiloxane (A) having, in each molecule: a UV-curable functional group; and a non-UV-curable monofunctional polycyclic functional group which may contain a hetero atom, the composition being substantially free of an organic solvent.

4. The UV-curable composition according to claim 2, wherein the viscosity of the entire composition, as measured at 25° C. using an E-type viscometer, is 500 mPads or less.

5. The UV-curable composition according to claim 2, wherein component (A) is a linear, branched, or cyclic organopolysiloxane expressed by the average compositional formula (1): 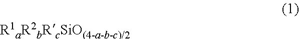
where R₁ represents a UV-curable functional group, and R² represents a non-UV-curable monofunctional polycyclic functional group which may contain a hetero atom;
R′ represents an unsubstituted or fluorine-substituted monovalent hydrocarbon group, excluding the UV-curable functional group and non-UV-curable monofunctional polycyclic functional group which may contain a hetero atom;
a, b, and c are numbers satisfying the following conditions: 1≤a+b+c≤3, 0.04≤a/(a+b+c)<0.5, and 0.04≤b/(a+b+c)<0.5, and there is at least one R¹ and at least one R² in each molecule.

6. The UV-curable composition according to claim 2, wherein the number of silicon atoms in component (A) is in the range of 2 to 10 on average.

7. The UV-curable composition according to claim 2, wherein component (A) is one or more organopolysiloxane having a UV-curable functional group and a non-UV-curable monofunctional polycyclic functional group which may contain a hetero atom, the organopolysiloxane being selected from the group consisting of:
linear organopolysiloxanes expressed by the following formula (2): 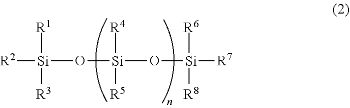
where, of all of the R¹ to R⁸ groups, one or more on average per molecule is a UV-curable functional group, one or more on average per molecule is a non-UV-curable monofunctional polycyclic functional group which may contain a hetero atom, and the remainder of the R¹ to R⁸ are each independently an unsubstituted or fluorine-substituted monovalent hydrocarbon group; and n is a number of 0 or more and 10 or less;
branched organopolysiloxanes expressed by average unit formula (3): 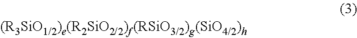
where R each independently represent a group selected from UV-curable functional groups, non-UV-curable monofunctional polycyclic functional groups which may contain a hetero atom, and unsubstituted or fluorine-substituted monovalent hydrocarbon groups; of all Rs, one or more on average is the UV-curable functional group and one or more on average is the non-UV-curable monofunctional polycyclic functional group which may contain a hetero atom; (g+h) is a positive number; e is 0 or a positive number; and f is a number in the range of 0 to 10);
cyclic organopolysiloxanes expressed by following formula (4): 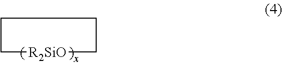
where R each independently represent a group selected from UV-curable functional groups, non-UV-curable monofunctional polycyclic functional groups which may contain a hetero atom, and unsubstituted or fluorine-substituted monovalent hydrocarbon groups; x is an integer from 3 to 10; and each molecule contains, on average, one or more UV-curable functional groups and, on average, one or more non-UV-curable monofunctional polycyclic functional group which may contain a hetero atom; and
mixtures of two or more of organopolysiloxanes arbitrarily selected therefrom.

8. The UV-curable composition according to claim 2, wherein the number of UV-curable functional groups in component (A) is two or less on average per molecule, and the number of non-UV-curable monofunctional polycyclic functional groups which may contain a hetero atom is two or less on average per molecule.

9. The UV-curable composition according to claim 2, wherein component (A) is a linear or branched organopolysiloxane having, only on a molecular chain end, a UV-curable functional group and non-UV-curable monofunctional polycyclic functional group which may contain a hetero atom, and having, on average, 5 or less silicon atoms.

10. The UV-curable composition according to claim 2, further comprising one or more organopolysiloxane (B) having, in each molecule, two or more UV-curable functional groups on average and not having a non-UV-curable monofunctional polycyclic functional group which may contain a hetero atom.

11. The UV-curable composition according to claim 2, further comprising an organosilicon compound (C) selected from the group consisting of one or more linear branched and cyclic organosilanes and organopolysiloxanes expressed by the following average compositional formula (5) and having, in each molecule, one UV-curable functional group and not having a non-UV-curable monofunctional polycyclic functional group which may contain a hetero atom: 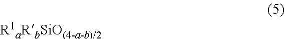
where R¹ represents a UV-curable functional group;
R′ represents an unsubstituted or fluorine-substituted monovalent hydrocarbon group excluding a UV-curable functional group; and
a and b are numbers satisfying the following conditions: 1<a+b≤4 and 0.04≤a/(a+b)≤0.25, and the number of R⁸ in each molecule is 1.

12. The UV-curable composition according to claim 10, wherein component (B) is a linear, branched or cyclic organopolysiloxane expressed by the average compositional formula (6): 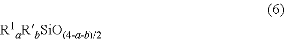
where R¹ represents a UV-curable functional group; and
R′ represents an unsubstituted or fluorine-substituted monovalent hydrocarbon group excluding a UV-curable functional group, a and b are numbers satisfying the following conditions: 1≤a+b≤3 and 0.04≤a/(a+b)≤0.5, and there are at least two R⁸ in each molecule.

13. The UV-curable composition according to claim 10, wherein component (B) is a silicon-containing compound having two or more UV-curable functional groups in each molecule, the compound being selected from the group consisting of:
linear organopolysiloxanes expressed by the following formula (2′): 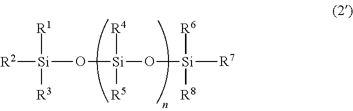
where, of all of the R¹ to R⁸ groups, there are two or more UV-curable functional groups in each molecule; the remainder of the R¹ to R⁸ each independently represent an unsubstituted or fluorine-substituted monovalent hydrocarbon group; and n is a numerical value of 0 or more and 8 or less;
branched organopolysiloxanes expressed by the average unit formula (3′): 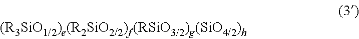
where R each independently represent a group selected from UV-curable functional groups and unsubstituted or fluorine substituted monovalent hydrocarbon groups; two or more on average of all R⁸ are UV-curable functional groups; (g+h) is a positive number; e is 0 or a positive number; and f is a number in the range of 0 to 10; and
cyclic organopolysiloxanes expressed by the following formula (4′): 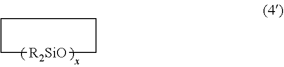
where R each independently represents a group selected from UV-curable functional groups and unsubstituted or fluorine-substituted monovalent hydrocarbon groups; x is an integer of 3 to 10; and two or more UV-curable functional groups are present in each molecule.

14. The UV-curable composition according to claim 10, wherein component (B) is a linear organopolysiloxane having, on average, 5 or less silicon atoms and having two UV-curable functional groups in each molecule.

15. The organopolysiloxane according to claim 1, wherein the UV-curable functional group is a cationic polymerizable functional group.

16. The organopolysiloxane according to claim 1, wherein the UV-curable functional group is an epoxy group-containing group.

17. The organopolysiloxane according to claim 1, wherein the non-UV-curable monofunctional polycyclic functional group which may contain a hetero atom is a group expressed by the following formula (7): 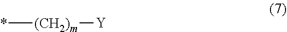
where m is a number of 0 or more and 6 or less; and Y represents a group selected from the group consisting of optionally substituted norbornanyl groups, optionally substituted norbornenyl groups, optionally substituted norpinane groups, optionally substituted norpinene groups, optionally substituted pinane groups, optionally substituted pinene groups, optionally substituted dicyclopentanyl groups, and optionally substituted dicyclopentenyl groups, and is bonded to a silicon atom expressed by *.

18. The organopolysiloxane according to claim 1, wherein the non-UV-curable monofunctional polycyclic functional group which may contain a hetero atom is an optionally substituted norbornanyl group.

19. The organopolysiloxane according to claim 1, wherein the one or more organopolysiloxane having a UV-curable functional group and a non-UV-curable monofunctional polycyclic functional group which may contain a hetero atom is 1-[2-(3,4-epoxycyclohexyl)ethyl]-3-norbornanyl-1,1,3,3-tetramethyldisiloxane or bis[2-(3,4-epoxycyclohexyl)ethyl]dimethylsiloxy-bisnorbornanyl dimethylsiloxysilane.

20. The UV-curable composition according to claim 2, wherein the viscosity of the entire composition, as measured at 25° C. using an E-type viscometer, is in the range of 5 to 50 mPa·s.

21. (canceled)

22. (canceled)

23. (canceled)

24. (canceled)
